(19) United States
(12) Patent Application Publication
(10) Pub. No.: US 2003/0066802 A1
(43) Pub. Date: Apr. 10, 2003

(54) Method for the elucidation of metabolism

(75) Inventors: Bernd Jastorff, Oyten (DE); Reinhold Stormann, Bremen (DE); Andreas Germanus, Bremen (DE); Jochen Franzen, Bremen (DE)

Correspondence Address: KUDIRKA & JOBSE, LLP, ONE STATE STREET, SUITE 1510, BOSTON, MA, 02109, US

(73) Assignee: Bruker Daltonik GmbH, Bremen (DE)

(21) Appl. No.: 10/244,826

(22) Filed: Sep. 16, 2002

(30) Foreign Application Priority Data
Sep. 18, 2001 (DE) 101 45 904.1

(51) Int. Cl. B01D 15/08

(52) U.S. Cl. 210/656; 210/632; 210/739; 436/161; 436/164; 436/171

(57) ABSTRACT

The invention relates to the elucidation of the breakdown of foreign substance in the metabolism of a liquid, chemical or biological reaction system by the analytical determination of the breakdown products (metabolites) produced. It is common practice for this elucidation to be carried out “blind”, i.e. without systematic prediction of the breakdown substances, by comparison and subtraction of analytical data sets, which are obtained by, for example, separating the substances in the liquid using liquid chromatography and measuring them using mass spectrometry before and after the foreign substance has been added. Unlike the current method, the invention consists of first calculating a “virtual” breakdown of the foreign substance, taking into account all the possible branches of the breakdown path according to a set of breakdown rules, which can be determined beforehand, so that the predicted potential breakdown products can be looked for selectively by using a more finally tuned method of measurement.

### FIELD OF THE INVENTION

The invention relates to the elucidation of the breakdown of foreign substance in the metabolism of a liquid, chemical or biological reaction system by the analytical determination of the breakdown products (metabolites) produced.

### BACKGROUND OF THE INVENTION

Here, the term “Elucidation of metabolism” is used as a general term for the analytical determination of the breakdown pattern of foreign substances in natural, usually bioreactive, liquid systems and the knowledge about the breakdown pattern gained as a consequence. The foreign substances are regularly external to the system. In respective reactive liquid systems, the foreign substances are subjected to constant chemical, enzymatic or microbiological breakdown, that is the “metabolism”. Here, the term “breakdown” refers to the types of reaction to which the foreign substance and the breakdown products which are generated in each case are subjected as well as the associated reaction kinetics. Examples of foreign substances are potential pharmaceuticals which are introduced into humans or animals by administration into the body fluids. Other examples, however, are substances which have been introduced into our environment, such as herbicides or insecticides by sprays or chemical accidents, i.e. they have been introduced into the microbiological ecosystem of “free” nature or have been absorbed from the latter by plants or animals.

The foreign substances are usually man-made and would not occur in the systems being examined without the intervention of man. There are, therefore, no “natural” breakdown mechanisms, i.e. none which would have taken place due to the adaptation of biological systems over the millions of years.

For the methods considered here, the foreign substances are known before the start of the analysis. In this case, therefore, we are not using unknown foreign substances.

Of high medical and economic interest is the study of the metabolism of potential pharmaceuticals in humans and animals, first in the elucidation of the different breakdown paths and then later with the emphasis on the kinetics of the processes and their statistical variations.

The breakdown of any chemicals in the natural environment, in plants or animals is of high ecological interest whether the chemicals are in the environment by intention or accident. In these cases, the interest in the elucidation of metabolism is extended to the development of an “environmentally compatible” chemical industry and to the banning of manufacture, or at least the banning of transport, of such chemicals which do not break down in our environment and which usually produce harmful effects. Examples of these chemicals are the polychlorinated biphenyls, which are already subject to a ban on manufacture in most countries.

In current practice, the search for the intermediate products in the breakdown of foreign chemicals usually takes place “blind”, i.e. without a systematic prediction and systematic search for the products which could be expected.

Liquid chromatography is generally used to separate the substances (HPLC=high performance liquid chromatography, often abbreviated to LC). Identification is then carried out by analyzing the mass spectra (MS=mass spectrometry). Several liquid samples are usually analyzed. These are extracted from the system being examined both before and at various times after adding the foreign substance. The data sets gained from these LC-MS analyses with measurement results from different samples are differentiated by a method of subtraction which is intended to show up differences in the occurrence of substances, but also differences in their concentration. However, because of the fluctuations which are always present in the chromatographic retention times, and because of the mutual influencing during ionization, this method of subtraction can not simply consist of the subtraction of mass spectra which are recorded simultaneously. Instead, an intelligent method involving continuous self correction must be applied. These methods are known in principle. They can consist of separating the overlapping concentration profiles of individual substances by calculation and only then carrying out a comparison of the concentrations of identical substances if this substance actually appears in the two data sets.

The composition of the bioreactive liquid systems which are examined, such as animal blood, is generally very complex—they may contain hundreds or even thousands of individual substances at very widely differing concentrations. The substances at low concentration produce a large amount of background noise—so-called chemical noise. This noise limits the detection of the products which occur if they can not be searched for specifically by means of prior knowledge of the substances which are to be expected. The differential calculation of the chromatographically separated spectral profiles of the substances near to the background therefore fails almost completely.

Modern methods for the elucidation of metabolism use mass spectrometers, such as an ion-trap mass spectrometer, with control programs for automatically recording the daughter spectra of automatically selected parent ions. These methods gives a better signal-to-noise ratio and therefore a better detection limit. However, for analyses without prior knowledge, these so-called MS-MS methods can only be used in principle if the ion signal produced by the quasi molecule ions of a breakdown product can be clearly identified above the chemical noise. Quasi molecule ions are defined here as the protonated molecules of the substance being looked for and, in borderline cases, of their alkali adducts. An intermediate substance of the breakdown can not be found if the chemical noise is as great as the useful signal at this point on the chromatogram or if the signal of a substance at a higher concentration which is relatively nearby overlaps.

This type of MS-MS analysis is also made more difficult by the adduct formations already mentioned which, in the case of positive ions, generally consist of the attachment of alkali ions. Thus many intermediate substances are susceptible to the attachment of the ubiquitous sodium ions. If these sodium adduct ions are selected for daughter-ion measurement by automatic methods, then it may happen that during the fragmentation process and formation of the daughter ions, the sodium ions will merely split off again. Since the latter can not be detected because of the limitation of the mass range in ion-trap mass spectrometers, no daughter ion signals at all are found here. The same is true for anion adducts when the mass spectra of negative ions are recorded.

### SUMMARY OF THE INVENTION

The basic idea of the invention is firstly to calculate the possible breakdown paths according to a predetermined set of breakdown rules (if possible, taking into account the breakdown kinetics using previously specified reaction rates) and secondly to use the resulting prediction of potential intermediate substances (and their expected concentrations for the time of sampling) by adapting the analytical method for the determination of the intermediate products of the breakdown. This can be achieved by adjusting the suitable parameters of the method so that these intermediate products can be detected more easily using optimized analytical methods than by “blind” searching using analytical methods which have not been adapted. In the following, these intermediate products of breakdown are simply referred to as “breakdown products”. In LC-MS methods, the setting of optimum, or at least favorable, parameters may relate to both chromatography and mass spectrometry. The column material, column dimensions, mixtures, pHs and gradient of solvent are parameters of the chromatography; the selective collection of parent ions of predetermined molecular weights for subsequent fragmentation and the recording of daughter-ion spectra at predetermined retention times are parameters of the mass spectrometry. The retention time windows for the breakdown products can also be determined from the knowledge and structure of the potential breakdown products or from tables etc.

The rules for chemical or enzymatic conversions, called “breakdown rules” here, need not be descriptions of a breakdown in the sense of a continuous reduction in size of the products. They may also be descriptions of intermediate products with larger molecular weights formed by oxidation, esterification, amidation, alkylation or adduct formation etc. In particular, the breakdown rules can imitate the known method of functioning of enzymes. Where possible, the breakdown rules should also contain reaction rates for the reactions so that expected concentration profiles of the breakdown products can be predicted against time. Since the reaction rates can vary by many orders of magnitude, even initial rough estimates are useful.

The detection or non-detection of intermediate products can then be used to correct the set of breakdown rules for the liquid system, such as the body fluid of a living organism, being examined. In borderline cases, the set of rules may be specific to a class of foreign chemicals, such as different types of derivatives of a potential pharmaceutical. However, for the sake of gaining general understanding, it would be ideal if the set of rules were generally applicable for the liquid system under examination. If the rules imitate the function of enzymes, then knowledge can be acquired about the enzyme system.

Calculations of the breakdown products are preferably carried out on a computer. There are several methods known for the computer-internal presentation of structures of a chemical compound, in particular, the so-called “connection tables”, which describe the bonds of each atom of a molecule with its neighbors in the form of a simple table. Computer programs can search for and find certain substructures in these connection tables. The breakdown rules in terms of the computer-internal presentation can be defined as the substitution of one substructure of the entire molecule (before the reaction) by another substructure (after the reaction) according to the bonding. For example, a rule can substitute the double bond between two carbon atoms with an epoxy group. However, it is also possible to define a breakdown reaction by a start substructure and several end substructures, where cleavage of the foreign substance is defined within the start substructure. The cleavage can refer to the opening of a ring structure, the splitting off of a terminal group or the splitting of a molecule into two fragment molecules. Condensations by ring closure may also be described.

The breakdown products form a tree with many branches in their hierarchical structure. The branches are formed either by competing breakdown reactions of a breakdown product or by cleavages. The tree of the breakdown products can be administered with a computer by using the hierarchical management tools present in modern operating systems, in particular by using the known graphical tree structure for the management of data hierarchies (tree structures).

Termination of the calculations can be predefined in a number of ways, such as the specification of the number of breakdown generations. However, it is better if the calculations are terminated on reaching known breakdown products in the liquid system. The structures of breakdown products known from other investigations can be held in a separate table. In this table, breakdown products which are no longer subject to breakdown but are instead removed from the liquid system, for example by the filtering function of the kidneys, can also be recorded.

The calculations of a branch of the breakdown can also be terminated if a compound with the same structure is found by comparing a newly calculated structure with the previously found structure. This method can be used especially for finding cyclical conversion chains, which are particularly critical for many liquid systems under examination if they produce no further breakdown branches.

A natural termination can also occur if the structure of an intermediate product can not be broken down at all according to the rules which have been entered.

Another criterion for a termination can be defined via the critical conditions for branching. In the case of two competing breakdown reactions, if one proceeds reliably at a slower rate than the other, for example by a factor of 10,000, then it is generally not worth pursuing the slow breakdown any further. The breakdown products of the slow breakdown can not then be found by analysis either.

Statements about the concentrations of the breakdown products as a function of time between the addition of foreign substance and extraction of the analytical sample can be made from the data based on the breakdown reaction rate. If the breakdown proceeds relatively fast along a chain of breakdown products, then these breakdown products will only be found at low concentrations, if at all. However, if the breakdown of another breakdown product proceeds relatively slowly, then this breakdown product will be expected to be found at relatively high concentrations.

The predicted breakdown products which are at sufficiently high concentration are used for the design of a favorable, if possible, optimal analytical method. Thus the chromatographic retention times of the breakdown products can be estimated by known rules. In suitably selected retention times windows, ions of the expected molecular weights can be made to accumulate in storage mass spectrometers such as high-frequency ion-trap mass spectrometers or ion-cyclotron mass spectrometers. The fragmentation which follows permits reliable statements about the occurrence of this breakdown substance via the measurement of the daughter-ion spectra.

In one refinement of the breakdown rules, data for partial removal of breakdown products from the reaction system can also be added to the kinetic reaction data. This partial removal can take place in certain storage organs of the system. An example of this is the storage of lipophilic breakdown products in fatty tissue where further breakdown is, at least temporarily, prevented.

The sensitivity of a selective method such as this is far superior to that of a “blind” method simply using subtraction for the detection of breakdown products. The increase in sensitivity can amount to several powers of 10.

### DETAILED DESCRIPTION

The rules governing the metabolic breakdown of a substance in a liquid reaction system are generally known, at least roughly. The system may be a chemical breakdown such as a photolytic breakdown but more often it is an enzymatic or microbiological breakdown, where the microbiological breakdown, in the end, can be attributed to enzymatic breakdown. If the breakdown is predominantly enzymatic, then the main effective enzymes, or even groups of enzymes, and their mechanism of action are usually known.

Although there are large numbers of enzymes in biological systems, the number of rules is generally easily manageable. A very complex system can be described with just approx. 20-30 general basic rules. However, the number of basic rules is not limited.

The breakdown rules for the system can be described as alterations to substructures in the foreign substances and intermediate products. The reactive changes, and therefore the rules, can be entered graphically with the aid of known graphic editors for chemical structures one substructure with its bonds to the rest of the molecule as the start configuration and (at least) a second, altered substructure as the final configuration for the conversion is entered for each rule. The substructure of the final configuration replaces the start structure while retaining the same bonds to the rest of the start molecule (with the exception that non-localized double bonds of ring systems can be converted to localized double bonds). If two or more substructures separated from each other are entered as the configuration of a breakdown, where each substructure takes over some of the bonds with the rest of the molecule, then this is a cleavage—either as the opening of a ring system or the fragmentation of an intermediate product. If only one of two final configurations is bonded to the rest of the structure, then this describes the splitting off of a terminal group. Kinetic constants for the rate of conversion can be added to each rule numerically. By using this set of rules, a computer program calculates the entire tree of breakdown products, step-by-step.

After each step, i.e. after each calculation of a breakdown product, the structure of this breakdown product is compared with the structure of the breakdown products which are already known and provided in a separate table. The table refers to breakdown products for the system in question where their further breakdown is already known and not to be examined any further. However, the table also contains all substances which are removed from the liquid system by other mechanisms such as precipitation or filtration via a kidney. The table may also contain substances which are temporarily removed from further breakdown due to temporary storage in organs such as fatty tissue. On the other hand, these types of storage processes can be recorded using special kinetic data, specially entered for the storage system. When the calculation comes to a known breakdown product in the list, the calculation for this branch is terminated. It is not always necessary, therefore, to carry out the calculation up to the end products, water and carbon dioxide (when pure hydrocarbon products are the foreign substances).

Each newly calculated breakdown product is also compared with all the breakdown products which have been calculated previously. If this structure is already present in the tree of the previous calculations, there is no need to pursue the breakdown any further in this case either. A correction for the expected concentration of this breakdown product can be carried out, because this breakdown product is made via two different paths. Where there are the same structures for two breakdown products, an investigation is also carried out to find out whether the reaction is a cyclical breakdown leading again to the same product due to the progressive change in a continuous cycle. The appearance of this kind of continuous cycle is particularly critical—if there is no exit branch from the cycle, metabolic breakdown may stop altogether.

The expected concentrations of the breakdown products can be determined from the kinetic data for the reaction rates. In this case, the half-lives for the breakdown can be classified as “fast” (milliseconds to approximately a minute), “moderately fast” (approximately one minute to a week) and “slow” (longer than a week). The intermediate products which are subject to fast breakdown can not, as a rule, be detected. Only if two or more fast breakdown reactions are competing with each other do they have an effect on the range of products expected. Slow breakdown reactions do not need—again, as a rule—to be pursued by calculation any further, at least they do not if competing reactions are taking place. Kinetic concentration profiles can be calculated from the moderately fast breakdown reactions. Once the entire tree of breakdown products is present, including an estimate of the expected concentrations at the time of sample extraction, then this can be used to construct a favorable analytical method for the expected breakdown products which can be detected. This method uses chromatography and mass spectrometry, both of which in operation modes as optimal as possible.

Liquid chromatography with subsequent ionization by electron spray and high frequency quadrupole ion-trap mass spectrometry are assumed as an example of an analytical method. As a general rule, the chromatography for the expected breakdown products is optimized for the properties of the expected substances according to the experience of the analyst (computer programs for optimizing chromatographic methods are also known). On the other hand, with the mass spectrometric method, more extensive calculations can help in the details.

For the optimally selected chromatographic method, the retention times of the individual breakdown products can be approximated according to known rules. An example of this would be to study the QSAR (Quantitative Structure Activity Relation) or QSRR (Quantitative Structure Retention Relation). The retention time essentially depends on the molecular weight and the presence of structural and functional groups which have an effect on the retention time due to special adhesion to or affinity to the solid phase of the chromatography system. Both the molecular weights and the presence of such functional groups can be determined by the computer from the connection tables. Where these rules are only roughly known, relatively wide retention windows must be allowed for the analysis which follows.

In these retention time windows, the breakdown products are then looked for selectively by mass spectrometry. This may happen, for example, by evaluating the mass-spectrometric chromatographic traces or by selectively accumulating the quasi-molecular ions from these breakdown products in the ion trap. In this case, only the ions from a small mass range are collected using known methods, and the mass range only includes the isotope masses of the quasi molecular ions. The ion trap is filled up to the saturation limit for the fragmentation process. The trapped ions are then fragmented by known means. Here, fragmentation concerns both the substances being looked at, if these are present, and all other collected substances of the same molecular weights. The superimposed daughter spectra of all parent ions are measured. Using the fragment ions and the known structure of the substances being looked for, it is usually easily possible to decide whether the predicted breakdown substance is present above the detection limit or not. If the fragmentation rules for the quasi-molecular ions are known, then this decision can largely be undertaken or at least supported by computer programs.

The results of such an analysis of breakdown products can then be used to fine-tune the set of breakdown rules. Initially, this may be in the form of a correction to the reaction rates, i.e. the kinetic data, to better suit the concentrations found. The rules themselves can also be refined. Thus, a basic rule which relates to a relatively small substructure can be converted into a new, refined rule by including neighboring structure components which have been shown to have an effect on the breakdown reaction. The reaction on which this rule is based can and will have another time constant. Since such a refinement of a rule stands in competition to the basic rule, it may be necessary to create a hierarchical order for the implementation of the rules. Alternatively, it may be sufficient to characterize the rules sufficiently accurately by the different time constants.

Finally, it is possible to introduce inhibiting rules for certain reactions.

A bioreactive liquid system need not be homogeneous. It can also be a multi-chamber system where different types of breakdown reactions can take place in each chamber and where the chambers are connected via diffusing or active fluid and substance transport. This may be a body with many organs which produces the breakdown of foreign substances. Bioreactive activity need not necessarily be dominant at the site of extraction for the sample. In animal bodies, for example, a large amount of metabolic breakdown takes place in the liver. The kidneys produce breakdown products which are often eliminated from the system.

The multi-chamber system can also contain temporary sinks for certain substances or groups of substances, i.e. organs which can provide intermediate storage for breakdown products. Such storage systems result from the equilibrium between the solubility of the breakdown products in fat and water. Substances which are preferably fat soluble may thus be deposited in the fatty tissue. The substance can not re-enter the aqueous part of the reaction system, where it can be broken down, until there is sufficient accumulation in the fatty tissue.

If further research also examines variations of the breakdown in different living organisms, then conclusions may be drawn about the enzyme system and the individual enzymes. The expression and effect of enzymes are extensively controlled by genomic data, largely through point mutations (SNPs=single nucleotide polymorphisms). In this way, the knowledge of the metabolism gains a new dimension, which can have an effect on the development of new pharmaceuticals.

Finally, the method presented here for the elucidation of metabolism amounts to a development of favorable analytical methods as well as to expanding the state of knowledge about metabolism as a consequence of increasingly refining the set of rules for the breakdown.

1. Method for elucidating the metabolism of foreign substances in a liquid reaction system with the aid of an analytical method for detecting the breakdown products, wherein the potential breakdown products are calculated beforehand with the aid of a set of break5 down rules, and the detection conditions of the analytical method are adjusted in favour of the potential breakdown products.

2. Method according to claim 1 wherein the expected concentrations of the breakdown products are also calculated by including the rate constants for the breakdown reactions defined in the breakdown rules and the analytical method is specially adjusted to the ex10 pected breakdown products.

3. Method according to claim 1 wherein the analytical method consists of a combination of chromatographic separation of the liquid components and their mass-spectrometric identification.

4. Method according to claim 3 wherein the chromatographic separation is liquid chromatographic separation and the substances are ionized by electron spray.

5. Method according to claim 3 wherein the chromatographic separation method is optimized by a knowledge of the type of potential breakdown products.

6. Method according to claim 3 wherein the single-mass chromatograms with the masses of the expected quasi-molecular ions are used for the mass spectrometric identification.

7. Method according to claim 3 wherein the daughter ion and/or the granddaughter ion spectra of each selected parent ion in particular are recorded for the mass-spectrometric identification.

8. Method according to claim 7 wherein the selection of the relevant parent ions to be collected in order to record the spectra of the daughter or granddaughter ions is based on a knowledge of the molecular weights of the potential breakdown products.

9. Method according to claim 8 wherein the chromatographic retention times of the potential breakdown products is predetermined as a result of a knowledge of the potential breakdown products and these breakdown products are selectively looked for mass spectrometrically within the correspondingly selected retention-time windows.

10. Method according to claim 1 wherein the breakdown rules concern the concurring integrated substitution of a substructure group in the parent substance by at least one other substructure group or by adduct formations.

11. Method according to claim 10 wherein the breakdown rules also contain values for the reaction rates.

12. Method according to claim 10 wherein the breakdown rules correspond to the action of enzymes.

13. Method according to claim 1 wherein the previous calculation of the breakdown products is carried out by an appropriate program in a computer and the breakdown products are stored in the form of a hierarchical tree structure which reflects other routes of the breakdown.

14. Method according to claim 13 wherein after calculation of a breakdown product, the computer searches for breakdown products of the same structure already calculated and terminates the calculation on finding such a breakdown product.

15. Method according to claim 13 wherein the calculation of further breakdown products is terminated whenever breakdown products are found which are stored in a specified table.

16. Method according to claim 13 wherein the calculation of other breakdown products is terminated when a branch of the breakdown reaction proceeds more slowly by a specified factor than other breakdown reactions for the same breakdown product.

17. Method according to claim 16 wherein the specified factor can be chosen.

18. Method according to claim 13 wherein the breakdown rules are entered in the computer graphically in each case via a start-substructure group and at least one end-substructure group using a structure editor.

19. Method according to claim 18 wherein the reaction times for the breakdown reactions for each rule are added numerically.
